(19) United States
(12) Patent Application Publication
(10) Pub. No.: US 2014/0189585 A1
(43) Pub. Date: Jul. 3, 2014

(54) Information Display System for a Machine

(71) Applicant: CATERPILLAR INC., Peoria, IL (US)

(72) Inventors: Jeffrey A. Brush, Peoria, IL (US); Dean F. Waldschmidt, Peoria, IL (US)

(73) Assignee: CATERPILLAR INC., Peoria, IL (US)

(21) Appl. No.: 13/730,032

(22) Filed: Dec. 28, 2012

(51) Int. Cl. G06F 3/048

(52) U.S. Cl. CPC G06F 3/048
USPC 715/808

(57) ABSTRACT

An information display system for a machine includes an operator interface, a data storage device, and a controller. A display screen of the operator interface has a machine performance information display section and a message display section disposed in offset relationship thereto. The controller is adapted to assemble a pop-up message from the data in the data storage device in response to receiving a signal indicative of a machine condition and to provide the pop-up message to the operator interface for display in the message display section of the display screen. The controller is adapted to remove the pop-up message from the display screen for a period of time in response to receiving a hide signal from the operator interface and to re-display the pop-up message in the message display section of the display screen after the period of time has elapsed if the machine condition still exists.

### TECHNICAL FIELD

This patent disclosure relates, generally, to an information display system for a machine, and, more particularly, to an information display system having an operator interface mounted in an operator cab of a machine.

### BACKGROUND

In a variety of engine-powered machines, monitoring devices are employed to detect the presence of various undesirable operating conditions, such as the overheating of the engine, low oil pressure, low fuel and the like. Indicators are provided to warn the operator of such conditions.

The degree of importance of the various monitored conditions can vary. For example, the air filter for the engine or the filter for the hydraulic fluid may gradually clog during operation of the vehicle. Generally, there is no need to remedy the situation until the end of the day when the machine returns for normal servicing and maintenance. A low fuel condition requires more immediate attention from the operator. A loss of engine oil pressure or a loss of hydraulic fluid represent conditions which require immediate operator attention to prevent damaging the machine.

Prior monitoring systems have detected the presence of undesirable conditions and then signaled the operator by means of dial indicators, indicator lamps, or audible means. The efficiency of these systems greatly depend upon the operator's careful attention to all of the various indicators and upon his judgment as to which may call for immediate correction. As the complexity of a vehicle increases, the number of monitored parameters generally increases. Therefore, the operator is required to direct more attention to the increasing number of indicators and less attention to operating the vehicle.

As the number of discrete warning messages increases, so does demand for space on the display screen. The indiscriminate display of the warning messages has often replaced productivity information within the same display. Conventionally, warning displays replace the entire screen and hide valuable productivity information of the machine.

U.S. Pat. No. 4,442,424 is entitled, “Method and System for Displaying Vehicle Operating Parameters in a Variable Format.” The '424 patent is directed to a display system wherein a plurality of engine operating parameters and useful information items are monitored by respective sensors. A control unit receives signals from the sensors to display the monitored items in a variable format on a single viewing screen in accordance with the conditions of the monitored items. When an abnormal condition of one of the monitored items is detected by the control unit, the display format of the monitored item with an abnormal condition is enlarged to give a warning indication. A pushbutton is provided for each of the monitored items to generate a display command signal in response to a manual command to provide a display of a desired item in an enlarged format.

It will be appreciated that this background description has been created by the inventors to aid the reader, and is not to be taken as an indication that any of the indicated problems were themselves appreciated in the art. While the described principles can, in some aspects and embodiments, alleviate the problems inherent in other systems, it will be appreciated that the scope of the protected innovation is defined by the attached claims, and not by the ability of any disclosed feature to solve any specific problem noted herein.

### SUMMARY

The present disclosure is directed to, in one embodiment, an information display system for a machine which includes an operator interface, a data storage device, and a controller. The operator interface includes a display screen. The display screen has a machine performance information display section adapted to display information indicating at least one machine parameter and a message display section adapted to selectively display a plurality of pop-up messages. The message display section is disposed in offset relationship to the machine performance information display section. The data storage device stores message data. The controller is operably arranged with the data storage device and the operator interface. The controller, in response to receiving a signal indicative of a first machine condition, is adapted to assemble from the message data in the data storage device a first pop-up message describing the first machine condition and to provide the first pop-up message to the operator interface for display in the message display section of the display screen. The controller is adapted to remove the first pop-up message from the display screen for a first period of time in response to receiving a first hide signal from the operator interface and to re-display the first pop-up message in the message display section of the display screen after the first period of time has elapsed if the first machine condition still exists.

In another embodiment, a machine adapted to be controlled by an operator includes a frame, a plurality of ground-engaging devices mounted to the frame, an engine operably coupled to at least one of the plurality of ground-engaging devices, an operator compartment supported by the frame, and an information display system. The information display system includes an operator interface, a data storage device, and a controller.

The operator interface is disposed within the operator compartment. The operator interface includes a display screen. The display screen has a machine performance information display section adapted to display information indicating at least one machine parameter and a message display section adapted to selectively display a plurality of pop-up messages. The message display section is disposed in offset relationship to the machine performance information display section. The data storage device stores message data. The controller is operably arranged with the data storage device and the operator interface. The controller, in response to receiving a signal indicative of a first machine condition, is adapted to assemble from the message data in the data storage device a first pop-up message describing the first machine condition and to provide the first pop-up message to the operator interface for display in the message display section of the display screen. The controller is adapted to remove the first pop-up message from the display screen for a first period of time in response to receiving a first hide signal from the operator interface and to re-display the first pop-up message in the message display section of the display screen after the first period of time has elapsed if the first machine condition still exists.

In another embodiment, a method of displaying operational information of a machine is described. In response to receiving an indication of a machine condition, a pop-up message is displayed in an information banner of a display screen of an operator interface. The pop-up message includes data describing the machine condition. Machine performance information is simultaneously displayed in a machine performance information display section of the display screen. The information banner is disposed in non-overlapping relationship with the machine performance information display section of the display screen. In response to receiving a snooze signal from the operator interface, the pop-up message is removed from the display screen for a period of time. After the period of time has elapsed, the pop-up message is re-displayed in the information banner of the display screen if the machine condition still exists.

Further and alternative aspects and features of the disclosed principles will be appreciated from the following detailed description and the accompanying drawings. As will be appreciated, the information display systems for a machine, the machines, and the methods of displaying operational information of a machine disclosed herein are capable of being carried out in other and different embodiments, and capable of being modified in various respects. Accordingly, it is to be understood that both the foregoing general description and the following detailed description are exemplary and explanatory only and do not restrict the scope of the appended claims.

### BRIEF DESCRIPTION OF THE DRAWINGS

FIG. 1 is a side elevational view of an embodiment of a machine suitable for use with an embodiment of an information display system for a machine constructed in accordance with principles of the present disclosure.

FIG. 2 is a schematic and diagrammatic view of an embodiment of an information display system for a machine constructed in accordance with principles of the present disclosure.

FIG. 3 is a front perspective view of an operator interface of the information display system of FIG. 2.

FIG. 4 is a rear perspective view of the operator interface of FIG. 3.

FIG. 5 is a front elevational view of the operator interface of FIG. 3, illustrating a display screen having a machine performance information display section and a message display section.

FIG. 6 is a front elevational view of the operator interface of FIG. 3 as in FIG. 5, but illustrating a pop-up message in the message display section.

FIG. 7 is a front elevational view of the operator interface of FIG. 3 as in FIG. 5, but illustrating an alert reminder symbol in the message display section after a pop-up message has been suppressed.

FIG. 8 is a front elevational view of the operator interface of FIG. 3 as in FIG. 7, but illustrating a diagnostics list in the machine performance information display section.

FIG. 9 is a front elevational view of an event detail display in the machine performance information display section.

FIG. 10 is a view of an embodiment of a pop-up message suitable for display in a dedicated information banner of a display screen.

FIGS. 11-13 are views of embodiments of a pop-up message suitable for display in a dedicated information banner of a display screen, where the pop-up messages comprise three different levels of warnings in a priority hierarchy.

FIG. 14 is a flow chart illustrating steps of an embodiment of displaying multiple pop-up messages in a dedicated information banner according to principles of the present disclosure.

FIG. 15 is a flow chart illustrating additional steps of an embodiment of displaying multiple pop-up messages in a dedicated information banner according to principles of the present disclosure.

### DETAILED DESCRIPTION

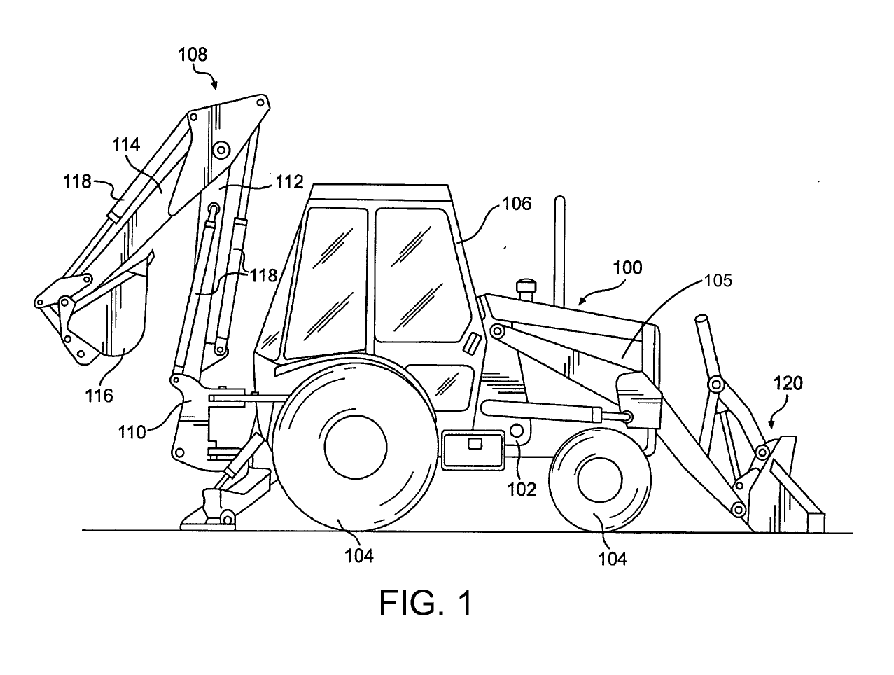

Referring now to the drawings, an exemplary embodiment of a machine 100 is shown in FIG. 1 which is suitable for use with an embodiment of an information display system constructed in accordance with principles of the present disclosure. The machine 100 is adapted to be controlled by an operator. The machine 100 includes a frame 102, a plurality of plurality of ground-engaging devices 104 mounted to the frame 102, an engine 105 operably coupled to at least one of the ground-engaging devices 104, and an operator compartment 106 supported by the frame 102. The illustrated ground-engaging devices 104 are in the form of wheels. In other embodiments, other suitable ground-engaging device can be used, such as, tracks or belts, for example.

In the exemplary embodiment shown, the machine 100 includes a mechanical linkage 108 having a swing frame 110, a boom member 112, a stick member 114, a work implement 116, and actuators 118. The actuators 118 provide movement and control to the mechanical linkage 108 as is known in the art. The actuators 118 can be any suitable device for providing selective movement of the mechanical linkage 108, such as hydraulic-powered cylinders or other types of actuators suitable for moving the mechanical linkage 108.

The illustrated machine 100 is of a type commonly referred to as a backhoe loader and can further include a front work implement assembly 120, such as, for example, a loader bucket assembly. The loader bucket assembly may be connected to the frame 102 at a front portion of the machine 100.

In other embodiments, the principles disclosed herein can be incorporated and used with other machines, such as fixed or mobile machines that are used in industries including mining, construction, forestry, farming, etc. Non-limiting examples of other mobile machines include commercial machines, such as trucks, cranes, earth moving vehicles, mining vehicles, cold planers, wheel loaders, backhoes, motor graders, track type tractors, hydraulic excavators, track type loaders, material handling equipment, farming equipment, marine vessels, aircraft, and other types of movable machines.

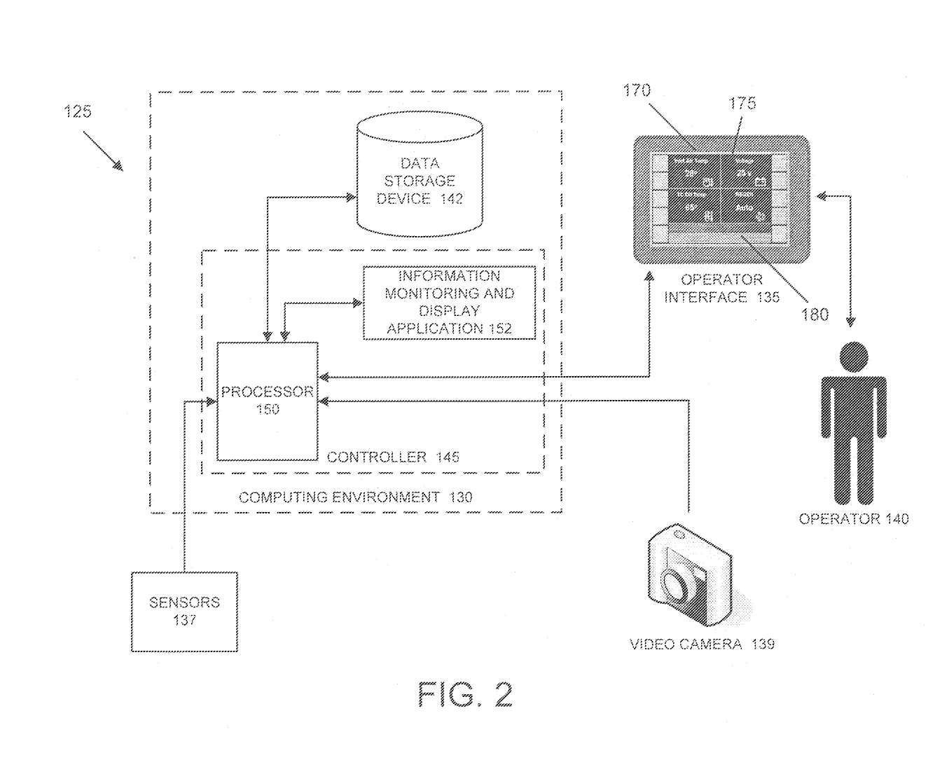

Referring to FIG. 2, an exemplary embodiment of an information display system 125 constructed in accordance with principles of the present disclosure is shown. The information display system 125 includes a computing environment 130 operably arranged with an operator interface 135, sensors 137, a video camera 139, or any combination thereof. The operator interface 135 can be disposed within the operator compartment 106 of the machine. An operator 140 can use the operator interface 135 to receive information from the information display system 125 and to provide inputs to various machine components through the operator interface 135. In the illustrated embodiment, the operator interface 135 is adapted to provide information in the form of visibly-displayed indicia. In some embodiments, an audio device can be associated with the operator interface 135 to provide audibly-perceptible information through a speaker.

The computing environment 130 can include a data storage device 142 storing message data and a controller 145. The controller 145 can be operably arranged with the data storage device 142, the operator interface 135, the sensors 137, and the video camera 139. The controller 145 can include a processor 150 and a non-transitory, tangible computer-readable storage medium bearing instructions comprising an information monitoring and display application 152. When executed by the processor 150, the information monitoring and display application 152 provides the controller 145 with the functionality to provide the display configurations described herein.

The data storage device 142 can generally include any type of system for storing data in non-volatile storage. This includes, but is not limited to, systems based upon: magnetic, optical, and magneto-optical storage devices, as well as storage devices based on flash memory and/or battery-backed up memory. The data storage device 142 can include a removable memory module, or a fixed memory module, or a combination of removable and fixed memory modules.

The data storage device 142 can be adapted to store message data for at least one pop-up message. In embodiments, the data storage device 142 stores message data for a plurality of pop-up messages. The data storage device 142 can be adapted to store operation manuals, performance and duty cycle history data, operator-specific information, workplace-specific information, machine-specific information, and any other type of information associated with the machine 100 and/or a geographical area associated with the location of the machine 100.

In an illustrated embodiment, the data storage device 142 includes a databases storing message data for a plurality of pop-up messages in tabular form, as shown in Table I. Each row of Table I can include message data associated with a particular machine condition. The first column includes a unique numeral—an Event ID (EID)—associated with the particular machine condition. The second column includes a numerical rank, e.g., a Warning Level, in a priority hierarchy assigned to the particular machine condition. The priority hierarchy can be organized according to the severity of, and/or the risk posed by, the particular machine condition. In the illustrated embodiment, warning events can be assigned to one of three ranks where Warning Level 3 is the most critical warning level. The third column includes a text string comprising a Description of the particular machine condition. The fourth column includes a text string comprising an identification of the particular System exhibiting the particular machine condition. The fifth column includes a text string comprising an identification of the nature of the Condition. The sixth column includes a text string comprising a corrective action (Action) for the operator to follow in response to the particular machine condition.

TABLE I

| | WARNING | | | | |
|---|---|---|---|---|---|
| EID | LEVEL | DESCRIPTION | SYSTEM | CONDITION | ACTION |
| 47 | 1 | Transmission Abuse | Trans Shift | ABUSE | Change |
| | | Warning | | | Operation |
| 47 | 2 | Transmission Abuse | Trans Shift | ABUSE | Change |
| | | Warning | | | Operation |
| 49 | 2 | Coasting in Neutral | Trans Shift | ABUSE | Change |
| | | Warning | | | Operation |
| 106 | 2 | High Front Brake | Brake Temp | HIGH | Change |
| | | Temp. | | | Operation |
| 107 | 2 | High Rear Brake | Brake Temp | HIGH | Change |
| | | Temp. | | | Operation |
| 155 | 2 | High Torque Converter | Torque Conv | HIGH | Change |
| | | Oil Temp. | Oil Temp | | Operation |
| 179 | 2 | Alternator Not | Charging | FAILURE | Service |
| | | Charging | System | | |
| 281 | 2 | Steering Hydraulic Oil | Steer Oil | RESTRICTION | Service |
| | | Filter Plugged | Filter | | |
| 327 | 3 | Low Output Transfer | OTG Press | LOW | Shutdown |
| | | Gear (OTG) Pressure | | | Safely |
| 328 | 3 | Output Transfer Gear | OTG Filter | RESTRICTION | Shutdown |
| | | (OTG) Filter Plugged | | | Safely |
| 329 | 3 | Transmission Filter | Trans Filter | RESTRICTION | Shutdown |
| | | Plugged | | | Safely |
| 330 | 3 | Transmission Output | Trans Speed | FAILURE | Shutdown |
| | | Speed Mismatched | Sens | | Safely |
| 542 | 2 | Low Steering Pump | Steer Oil | LOW | Service |
| | | Pressure | Press | | |
| 542 | 3 | Low Steering Pump | Steer Oil | LOW | Shutdown |
| | | Pressure | Press | | Safely |
| 556 | 2 | Low Brake Pump | Brake Oil | LOW | Service |
| | | Pressure | Press | | |

The event data in Table I are representative of machine parameters suitable for monitoring and for diagnostic analysis using the principles of the present disclosure. In other embodiments, other parameters well known in the art can be readily used with the principles of the present disclosure.

The operator interface 135 can be configured to provide the operator 140 with an operable interface to systems of the machine 100. The operator interface 135 is coupled to the controller 145 to receive display data. The operator interface 135 can be disposed within the operator compartment 106 of the machine 100. The operator interface 135 includes a display screen 170 having a machine performance information display section 175 adapted to display information indicating at least one machine parameter and a message display section 180 adapted to selectively display a plurality of pop-up messages. The message display section 180 is disposed in offset relationship to the machine performance information display section 175. In embodiments, the message display section 180 comprises a dedicated information banner.

In embodiments, the brightness and/or color of the background of the display screen 170 can be adjusted. For example, in some embodiments, the display screen 170 can be toggled between a day mode and a night mode, for example. The day mode can have a different color scheme and/or brightness than the night mode.

The sensors 137 are in electrical communication with the controller 145. Each sensor 137 can be adapted to detect an operational parameter of the machine 100 and to provide a signal indicative of the detected operational parameter to the controller 145. In embodiments, the controller 145 is adapted to provide operational parameter information to the operator interface 135 for display in the machine performance information display section 175 of the display screen 170.

The sensors 137 can comprise any suitable sensor capable of detecting at least one machine condition. Exemplary sensors 137 can include a variety of physical sensors monitoring safety and operational conditions of the machine 100, such as hydrogen detection sensors, temperature sensors, voltage and current sensors, speed sensors, flow sensors, position sensors, radar-based sensors, laser-based sensors, and any other type of sensor that can be useful to monitor at least one operation condition of the machine 100.

In embodiments, one or more of the sensors 137 may be associated with an on-board module, which can include one or more control modules or interface modules within the machine 100 that control the particular sensor 137 and on-board components or other types of sub-components. The on-board module may be interposed between the particular sensor 137 and the processor 150. For example, an on-board module can include an Engine Control Module (ECM), a power system control module, a Global Positioning System (GPS) interface device, an attachment interface that connects one or more sub-components, and any other type of device that the machine 100 may use to facilitate and/or monitor operations of the machine 100 during run time or non-run time conditions (i.e., machine engine running or not running, respectively). In such embodiments, the controller 145 can be adapted to respond to signals received from the sensors 137 either directly or indirectly through an on-board module.

The video camera 139 can be adapted to selectively provide a video signal for display in the machine performance information display section 175 of the display screen 170. In embodiments, the processor 150 can be adapted to determine whether to overwrite information disposed in the machine performance information display section 175 of the display screen 170 with a video image from the video camera 139. In embodiments, the image data provided by the video camera can be directed to the processor 150, which can be adapted to selectively display the image data in the machine performance information display section 175 of the display screen 170.

The video camera 139 can be mounted at any suitable location on the machine 100. For example, in embodiments, the video camera is mounted such that it captures a video image of the area to the rear of the machine 100. In some embodiments, the video camera 139 can be rear-mounted and be adapted to be activated in two ways. The processor 150 can be adapted to automatically display the image data from the video camera 139 in the machine performance information display section 175 of the display screen 170 when the machine 100 is placed in reverse. The image data will continue to be so displayed until the machine 100 is taken out of reverse. The processor 150 can also be adapted to display image data from the video camera 139 in the machine performance information display section 175 of the display screen 170 in response to receiving a camera display signal from the operator interface 135. The processor 150 can be adapted to toggle back to a prior display configuration and cease the display of image data from the video camera 139 in response to a return signal from the operator interface 135.

In some embodiments, the video camera 139 is adjustably mounted such that the viewing angle of the video camera 139 can be varied over a range of travel. Thus, the video camera 139 can be mounted in a way to capture a video image of a position in a blind spot of the operator 140, which in turn can be viewed by the operator 140 in the machine performance information display section 175 of the display screen 170.

In embodiments, the mounting position of the video camera 139 can be varied. In embodiments, a plurality of video cameras can be mounted to the machine 100 and selectively used to display video images in the machine performance information display section 175 of the display screen 170.

In embodiments, the controller 145 is adapted to collect machine performance information from the sensors 137 and process the collected machine performance information for selective display by the operator interface 135. Machine performance information can include, for example, information associated with fuel consumption, the temperature of machine components and fluids, the pressure of machine fluids, fluid levels, fluid consumptions, load weight, speed, propulsion torque vs. speed history vs. vehicle position, duty cycle information for power-consuming components, idle time, number of engine starts, load type, work machine type, terrain type, terrain grade, type of material manipulated by the machine 100, hours of operation, work site parameter data, and any other type of information related to the machine 100, a work site, and/or operations associated with the work site. For example, the processor 150 may execute a software program to collect and display through the operator interface 135 information reflecting the ground speed of the machine 100.

The processor 150 can be adapted to monitor operational conditions and to display warning information on the operator interface 135 in response to detected machine conditions, including fault conditions. For example, the processor 150 can be adapted to collect oil pressure information from one or more of the sensors 137. The processor 150 can be adapted to display a warning pop-up message containing warning information to indicate to the operator 140 that the oil pressure is outside of threshold values. The processor 150 can be adapted to display a warning pop-up message containing warning information to indicate to the operator 140 that the fuel level is below a threshold value. Further, the processor 150 can be adapted to automatically respond to machine conditions to help an operator maintain or place the machine 100 in a safer condition or prevent the machine 100 from operating out of a safe operating range.

In certain embodiments, the processor 150 can be adapted to display one or more recommended corrective actions corresponding to a detected machine condition triggering a warning event. The corrective actions can include recommendations for altering the operation of the machine 100. For instance, in addition to providing display data reflecting warning information for a particular operational condition, the processor 150 can be adapted to generate a suggested course of action that the operator 140 of the machine 100 can perform to correct the abnormal condition and/or to place the machine 100 in a relatively safer operating state. Accordingly, methods and systems following principles of the present disclosure can provide recommendations of corrective actions to address a range of machine conditions that are unsafe and/or harmful to the machine 100 or the operator 140.

In embodiments, the controller 145 is adapted to assemble a first pop-up message from the data in the data storage device 142 in response to receiving a signal indicative of a first machine condition and to provide the first pop-up message to the operator interface 135 for display in the message display section 180 of the display screen 170. The first pop-up message can include data describing the first machine condition.

The controller 145 can be adapted to remove the first pop-up message from the display screen 170 for a first period of time in response to receiving a first hide signal from the operator interface 135. The controller 145 can be adapted to re-display the first pop-up message in the message display section 180 of the display screen 170 after the first period of time has elapsed if the first machine condition still exists. The controller 145 can be adapted to display an alert reminder symbol in the message display section 180 of the display screen 170 after removing the first pop-up message from the display screen 170 for the first period of time in response to receiving the first hide signal from the operator interface 135.

In embodiments, the controller 145 is adapted to assemble a second pop-up message from the data in the data storage device 142 in response to receiving a signal indicative of a second machine condition and to provide the second pop-up message to the operator interface 135 for display in the message display section 180 of the display screen 170. The second pop-up message includes data describing the second machine condition. In embodiments, the controller 145 is adapted to determine whether the first pop-up message is displayed in the message display section 180 of the display screen 170 and, if so, rank the first pop-up message and the second pop-up message in a priority hierarchy and sequentially display the first pop-up message and the second pop-up message in an order according to rank.

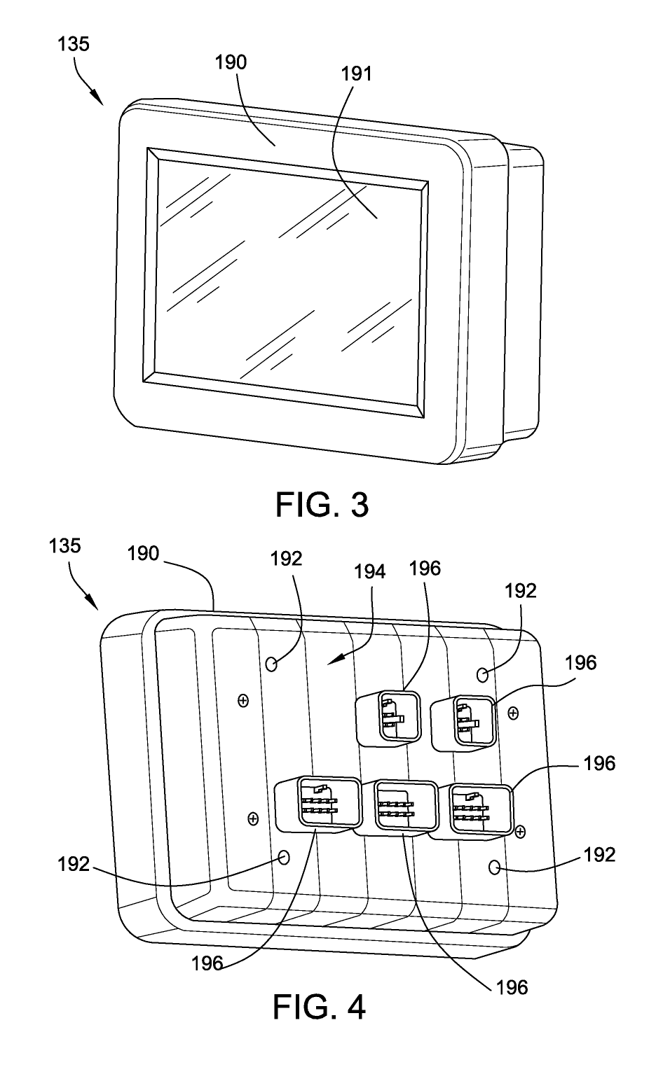

Referring to FIGS. 3 and 4, the illustrated embodiment of the operator interface 135 comprises a liquid crystal display device 190. In embodiments, the operator interface 135 may comprise another type of display, a console, a keyboard, push buttons, voice recognition devices, a laptop computer, speakers, and/or other interfaces well known in the art. In embodiments, the operator interface 135 can include any type of display device that presents information.

Referring to FIG. 3, the illustrated liquid crystal display device 190 includes a touch screen 191 as the display screen 170 adapted to display information to the operator 140 of the machine 100 and to receive instructions from the operator 140 for transmission to the controller 145 via finger touch input. The touch screen 191 can be any suitable size, such as a seven-inch screen, for example, with any suitable aspect ratio, such as 1.66:1 or industry reference “Super 16,” for example. The illustrated touch screen 191 comprises a color screen. In other embodiments, different display screens 170 can be used.

The touch screen 191 can be selectively activated using capacitive-touch technology as is well known to those skilled in the art. The touch screen 191 can be configured to detect anything which is conductive or has a dielectric different than that of air. In embodiments, the touch screen 191 can be activated based on a human finger touch applying a predetermined amount of force to the touch screen 191. In embodiments, the touch screen 191 can be configured to respond to immediate touch activation, push and hold activation, and activation upon lift off.

Referring to FIG. 4, the illustrated liquid crystal display device 190 is capable of being mounted within a panel configuration in the operator compartment 106 or as a stand-alone device. Four mounting holes 192 are located on a back surface 194 of the liquid crystal display device 190 and are in spaced relationship to each other to facilitate the mounting of the display device 190. Suitable electrical connectors 196 can accessible through the back surface 194 to provide an electrical connection between the operator interface 135 and a power source, the controller 145, and other electrical components.

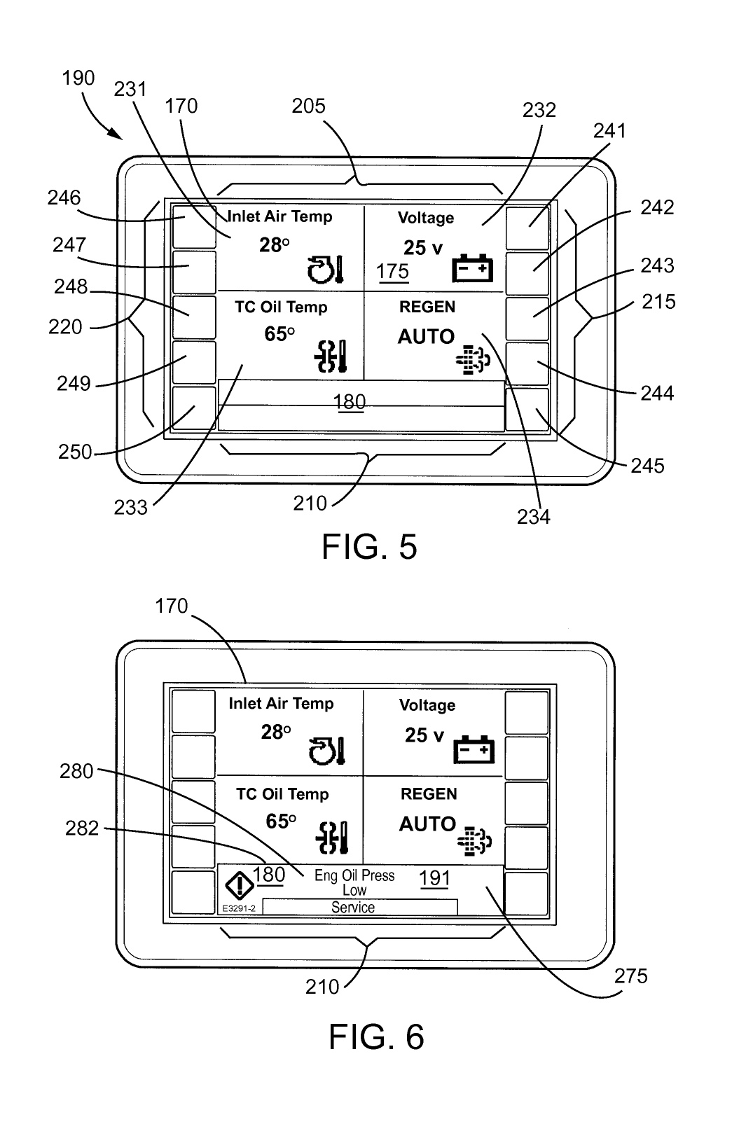

Referring to FIG. 5, the display screen 170 can be divided into more than one area for information and operator activation. The display screen 170 of the illustrated liquid crystal display device 190 can include a main information area 205 comprising the machine performance information display section 175 adapted to display information indicating at least one machine parameter, an information banner area 210 comprising the message display section 180 adapted to selectively display a plurality of pop-up messages, a primary navigation area 215, and a secondary navigation area 220. The message display section 180 is disposed in offset relationship to the machine performance information display section 175.

The main information area 205 can be adapted to provide information formatted for the display screen 170 as well as physical interaction points dedicated to navigation or changes made within the context of the visible screen. The physical interaction point can be suitably labeled to indicate the function of each navigation point.

The main information area 205 can display the machine performance information display section 175. In the illustrated home page of FIG. 5, the machine performance information display section 175 contains four performance quadrants 231, 232, 233, 234. Each performance quadrant 231, 232, 233, 234 can be configured to display information concerning at least one machine parameter. In embodiments, a scroll bar can be provided when there is more than a single page of machine performance information available for viewing. In embodiments, the content of each performance quadrant 231, 232, 233, 234 can include machine-specific values and reflect actual, current operating conditions.

The information banner 210 is adapted to provide a location for relevant operator information and other information, (e.g., temperature), such as is shown in FIG. 13. The information banner 210 is also reserved for selective display of one of a plurality of pop-up messages provided by the controller 145 to the operator interface 135 upon determining a triggering machine condition exists. The size of the information banner 210 and the pop-up messages are controlled to allow an activated pop-up message to overwrite the sacrificial information ordinarily displayed in the information banner.

In embodiments, the controller 145 can be adapted to provide sacrificial information to the operator interface 135 for display in the message display section 180 of the display screen 170 when the controller 145 has not received a signal indicative of a machine condition predetermined to trigger a pop-up message. The controller 145 can be adapted to overwrite the sacrificial information in the message display section 180 of the display screen 170 with the pop-up message when the controller 145 receives a signal indicative of the machine condition.

The controller 145 can be adapted to display different pages of display configurations on the display screen 170 in response to inputs received from the operator 140 through the operator interface 135. Typical navigation can be provided through predefined active areas on the right and left side of the display screen 170.

The primary navigation area 215 and the secondary navigation area 220 can each be equipped with five navigation buttons or touch elements 241, 242, 243, 244, 245, 246, 247, 248, 249, 250 adapted to launch menu pages for display in the main information area 205. Each of the touch elements 241, 242, 243, 244, 245, 246, 247, 248, 249, 250 can include an icon indicating its respective navigation function. In the event that a particular navigation button 241, 242, 243, 244, 245, 246, 247, 248, 249, 250 is not needed in a given situation, a non-active blank button can be displayed in its place.

The illustrated primary navigation area 215 is disposed on the right-hand side of the display screen 170. The five navigation buttons 241, 242, 243, 244, 245 of the primary navigation area 215 correspond to five different navigation categories. At the activation of one of the navigation buttons 241, 242, 243, 244, 245 of the primary navigation area 215, a top-level menu for the navigation category linked to the activated navigation button appears in the main information area 205. Any machine performance information in the main information area 205 can be overwritten. The top-level navigation menu for each navigation category can include a listing of a number of sub-menus. For example, in embodiments, the five navigation buttons 241, 242, 243, 244, 245 of the primary navigation area 215 can correspond to a DISPLAY navigation category, a MACHINE navigation category, a TOTALS INFORMATION navigation category, a SERVICE navigation category, and an OPERATOR navigation category.

In embodiments, the DISPLAY navigation category can include sub-menu pages selectively displayable in the main information area 205, including sub-menus containing settings relating to the means by which the display device 190 provides the machine information to the operator 140. Exemplary sub-menus include settings for the language in which machine information is displayed, the brightness of the display screen 170, and the measurement units in which machine information is displayed (e.g., English or metric).

In embodiments, the MACHINE navigation category can include navigation to machine systems with available values. For example, the MACHINE navigation category can include sub-menus for the Engine, Transmission, Chassis, Auto Retarder, Traction Control, Hoist, Brake, Shift and Filter. The sub-menus can launch a Machine Status page in the main information area 205 for the selected system populated with machine-specific values relating to the selected machine component.

In embodiments, the TOTALS INFORMATION navigation category can provide navigation to a desired type of totals. For example, the totals information navigation category can include sub-menus for Lifetime Totals or Trip Totals. Each sub-menu can launch a page populated with machine-specific values for, e.g., distance traveled, operating hours, and fuel used.

In embodiments, the SERVICE navigation category can provide navigation to machine service configuration settings. This area can be password-protected to prevent unauthorized users from changing these settings.

In embodiments, the OPERATOR navigation category can provide navigation to functions involving the identification of the particular operator operating the machine 100 at a given time. For example, sub-menus in the operator navigation category can include Select, Edit, Create, and Delete adapted to allow an operator profile to be selected from a menu list, edited, created and added to the menu list, or deleted, respectively.

The illustrated secondary navigation area 220 is disposed on the left-hand side of the display screen 170. The five navigation buttons 246, 247, 248, 249, 250 of the secondary navigation area 220 correspond to five different “hotkey” navigation buttons which are configurable for a given machine application. The hotkey navigation buttons 246, 247, 248, 249, 250 of the secondary navigation area 220 can be configured to provide a constant activation point for the most commonly-used features of the operator interface 135. At the activation of one of the hotkey navigation buttons 246, 247, 248, 249, 250 of the secondary navigation area 220, the operator 140 can navigate directly to the requested feature.

Referring to FIG. 6, an embodiment of a pop-up message 275 is shown in the information banner 210. The pop-up message 275 can be displayed in the information banner 210 in response to receiving an indication of a machine condition. The pop-up message 275 includes data describing the machine condition. The pop-up message 275 can include a text string containing one or more abbreviated words. The pop-up message 275 can be formatted to provide the message information in a condensed, understandable condition for the operator 140. In the illustrated pop-up message 275, the controller 145 is displaying a pop-up message corresponding to the detected machine condition of low engine oil pressure. The dedicated information banner 210 is disposed in non-overlapping relationship with the machine performance information display section 175 of the display screen 170 such that machine performance information can be simultaneously displayed in the machine performance information display section 175.

Embodiments of a pop-up message can be used to inform the operator of a pending or immediate machine condition. Pop-up messages can be used for a variety of information conditions and severities. In embodiments, the severity of a pop-up message can be configured as an information pop-up message (e.g., non-critical) or a warning pop-up message (e.g., potentially harmful or unsafe or likely to lead to the machine 100 ceasing to operate).

In embodiments, if more than one pop-up message is active, the controller 145 can be adapted to rank the active pop-up messages according to a priority hierarchy. The controller 145 can be adapted to sequentially display the active pop-up messages in an order according to rank for a predetermined period of time. For example, in embodiments, the controller 145 can be adapted to sequentially display each active pop-up message for a period of five seconds.

In embodiments, the pop-up message 275 can be configured to have interactions that provide additional information and allow the display to return to the previous information after acknowledgement. For example, in embodiments, the display screen 170 comprises a touch screen 191 configured to trigger a hide signal in response to a human finger touching the message display section 180 of the display screen 170 with a predetermined amount of force. The illustrated pop-up message 275 includes a snooze activation point 280 comprising any location within a pop-up message area box 282. Touching the pop-up message area box 282 can trigger the hide signal which is sent to the controller 145 to “snooze” or remove the pop-up message 275 for a predefined snooze time.

Once the displayed pop-up message 275 is snoozed, the controller 145 can automatically show any other active pop-up messages for active machine conditions. In the situation where the controller 145 assembles a second pop-up message from the data in the data storage device 142 in response to receiving a signal indicative of a second machine condition and provide the second pop-up message to the operator interface 135 for display in the message display section 180 of the display screen 170, the active second pop-up message, which includes data describing the second machine condition, can be displayed in the message display section 180. The controller 145 can be adapted to remove the second pop-up message from the display screen 170 for a second period of time in response to receiving a second hide signal from the operator interface 135. The controller 145 can re-display the second pop-up message in the message display section 180 of the display screen 170 after the second period of time has elapsed if the second machine condition still exists.

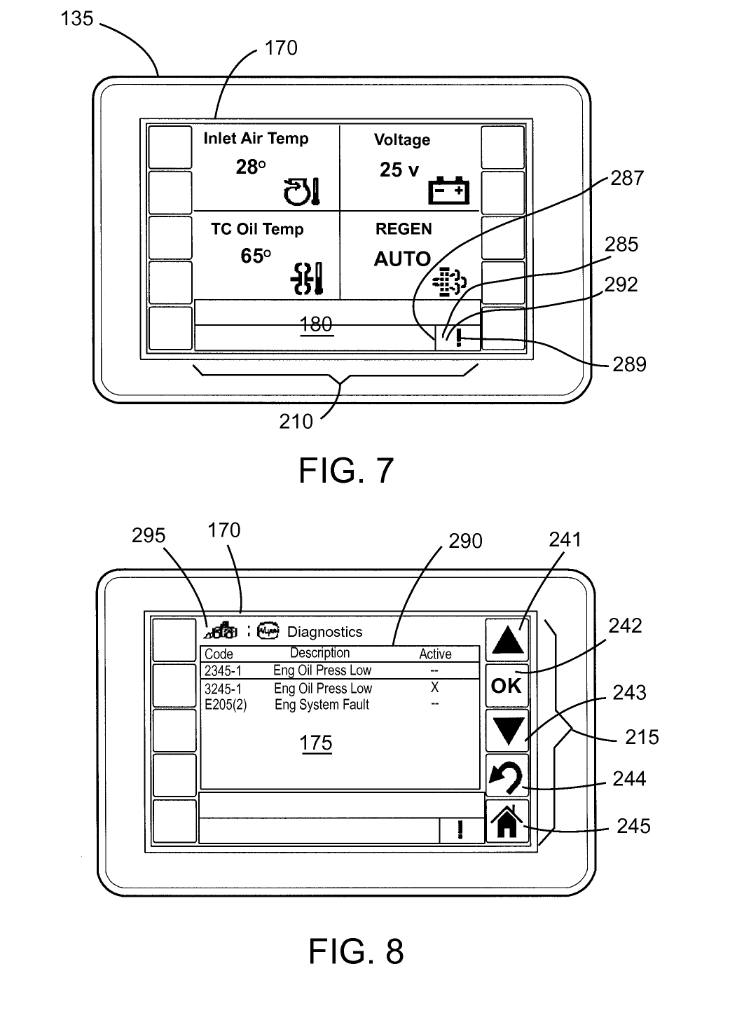

Referring to FIG. 7, if all active pop-up messages have been suppressed, the controller 145 can be adapted to display an alert reminder symbol 285 in the dedicated information banner 210. The alert reminder symbol 285 can be displayed until all of the snoozed pop-up messages become inactive, a new pop-up message is displayed in the information banner 210, or a snoozed pop-up message is still active after its snooze period has elapsed and it is re-displayed. The illustrated alert reminder symbol 285 is a box 287 containing an exclamation point 289 disposed in a lower right hand corner of the dedicated information banner 210.

In embodiments, the controller 145 can be adapted to display a predefined set of sacrificial information in the message display section 180 of the display screen 170 after receiving the hide signal from the operator interface 135. This sacrificial information can be overwritten when the snooze time for the pop-up message 275 elapses or a new machine condition triggering a second pop-up message occurs.

In embodiments, the controller 145 is adapted to display the alert reminder symbol 285 in the message display section 180 of the display screen 170 after removing the pop-up message 275 from the display screen 170 for the predetermined snooze time in response to receiving the hide signal from the operator interface 135. In embodiments, the controller 145 can be adapted to display the alert reminder symbol 285 in the message display section 180 of the display screen 170 until the period of time for the snooze operation has elapsed and the pop-up message 275 is re-displayed in the message display section 180 of the display screen 170 or until the controller 145 determines the machine condition triggering the pop-up message 275 no longer exists, whichever occurs first.

The controller can be adapted to display the alert reminder symbol 285 in the message display section 180 of the display screen 170 once all active pop-up messages have been snoozed. For example, in the case of two active pop-up messages, the controller 145 can be adapted to display the alert reminder symbol 285 in the message display section 180 of the display screen 170 after removing the first pop-up message and the second pop-up message from the display screen 170 in response to receiving the first hide signal and the second hide signal, respectively, from the operator interface 135. In embodiments, the controller 145 can be adapted to display the alert reminder symbol 285 in the message display section 180 of the display screen 170 until the first period of time has elapsed and the first pop-up message is re-displayed in the message display section of the display screen, the second period of time has elapsed and the second pop-up message is re-displayed in the message display section of the display screen, or until the controller 145 determines both the first machine condition and the second condition no longer exist, whichever occurs first.

In embodiments, the controller 145 can be adapted to assign to each active pop-up message a rank in a priority hierarchy. Each pop-up message can include indicia signifying the rank of the respective pop-up message in the priority hierarchy. The alert reminder symbol 285 can include indicia corresponding to the indicia of the highest rank of the active pop-up messages. In embodiments, the indicia comprise a plurality of different colors which correspond to different ranks in the priority hierarchy, and the color of the box 287 containing the exclamation point can be colored the color corresponding to the highest level of the active pop-up messages that have been snoozed. For example, in one embodiment, the priority hierarchy includes a Warning Level 1 indicated by the color grey, a Warning Level 2 indicated by the color yellow, and a Warning Level 3 indicated by the color red.

Referring to FIG. 8, the controller 145 can be adapted to display a diagnostic list 290 in the machine performance information display section 175 in response to receiving a diagnostic list signal from the operator interface 135. A diagnostics summary menu can be provided to display the diagnostic list 290 which can comprise a log of events that are active and inactive. For example, the diagnostic list 290 can include a list of the pop-up messages received, indicating the event identification number, the description, and the status (active or inactive) of each pop-up message.

In embodiments, the alert reminder symbol 285 includes a diagnostic list activation point 292 comprising any location within the box 287. Touching within the box 287 of the alert reminder symbol 285 (see FIG. 7) can trigger the diagnostic list signal which is sent to the controller 145 to display the diagnostic list 290.

Referring to FIG. 8, when a navigation category menu is launched, the functionality of the touch elements 241, 242, 243, 244, 245 in the primary navigation area 215 can change to menu navigation buttons until the operator 140 selects to return to a home page wherein the main information area 205 displays information indicating at least one machine parameter in the machine performance information display section 175. For example, while in machine diagnostics navigation category, the touch elements 241, 242, 243, 244, 245 of the primary navigation area 215 can respectively function as UP, OK, DOWN, BACK and HOME menu navigation tools and contain an icon indicating their function (see FIG. 8).

An UP navigation button 241 can be activated to navigate the diagnostic list 290 in an upward direction. A DOWN navigation button 243 can be activated to navigate the diagnostic list 290 in a downward direction. An OK button 242 can be activated to select a highlighted item and/or confirm an action when a confirmation pop-up message is visible. A BACK button 244 can be activated to navigate to the previous screen and/or cancel an action. A HOME button 245 can be activated to navigate to the home page of the display screen 170 from anywhere within the navigation levels of the operator interface 135.

Each page displaying a menu or sub-menu can include a bread crumb banner 295 (such as in the upper left-hand corner of the display screen 170) displaying information indicating the navigated location within the menu structure. In embodiments, information in the bread crumb banner 295 can be configured to display a symbol and/or text indicating the current screen and the previous screen. After three levels of navigation, a text string can be used in the bread crumb banner 295.

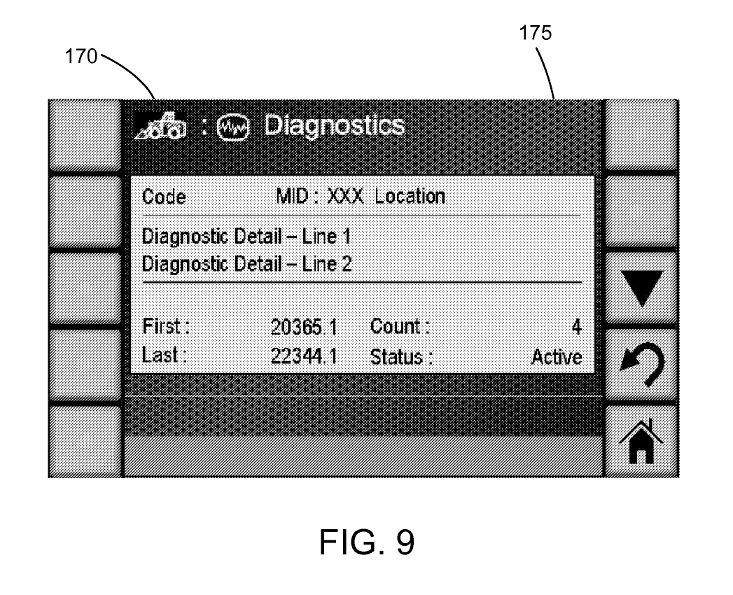

Referring to FIG. 9, in embodiments, an entry in the diagnostic list 290 of FIG. 8 can be selected to launch a diagnostic details menu in the machine performance information display section 175 of the display screen 170. The diagnostics detail menu can include additional data concerning the machine condition that triggered a particular pop-up message.

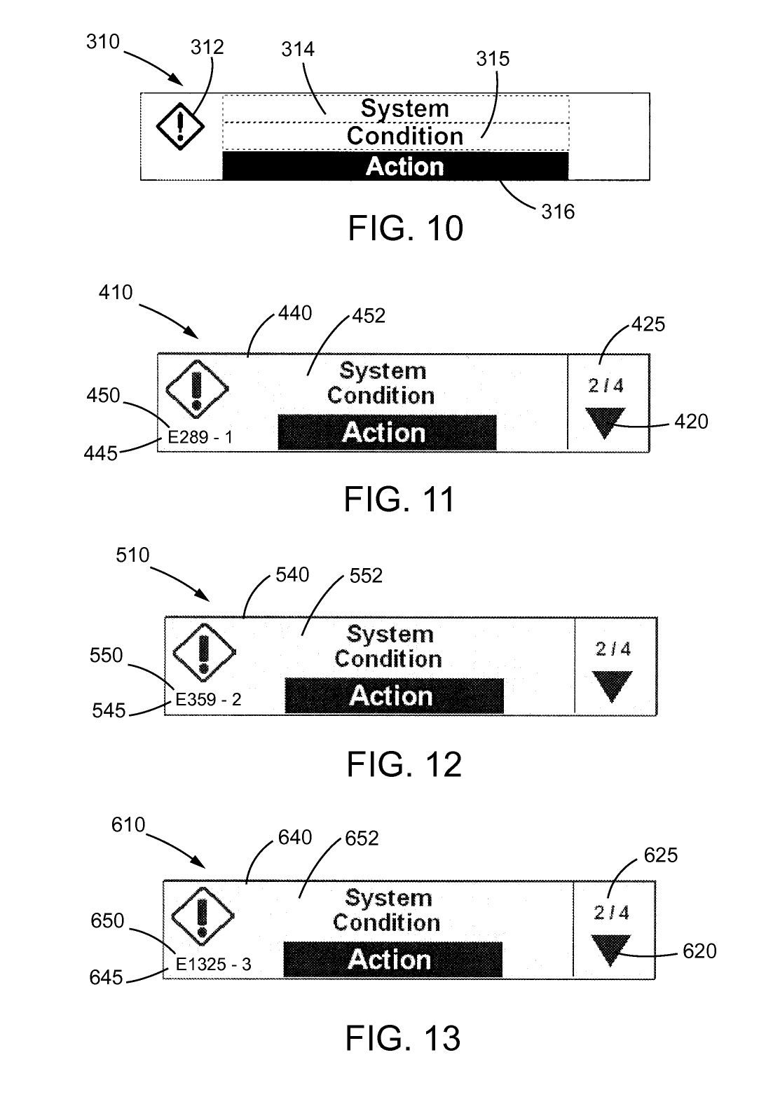

Referring to FIG. 10, an embodiment of a pop-up message configuration 310 is shown. The illustrated pop-up message configuration 310 includes a warning symbol 312 and a plurality of display field areas 314, 315, 316 for displaying data from the data storage device 142 regarding the detected machine condition. For example, the display field areas 314, 315, 316 can correspond to the following information categories: system, condition, and action. The system display field area 314 contains information identifying which machine system is experiencing the condition. The condition display field area 315 contains information identifying the particular condition detected. The action display field area 316 contains information identifying a course of action for the operator to take in response to the detected machine condition.

Referring to FIG. 11, in embodiments, the controller 145 can be adapted to provide a pop-up message 410 with a scroll activation point 420 comprising a scroll arrow touch element when more than one pop-up message is active. Touching the scroll arrow touch element 420 sequentially displays active pop-up messages according to a priority hierarchy.

In embodiments, the controller 145 is adapted to rank the active pop-up messages in the priority hierarchy. The controller can be adapted to sequentially display the active pop-up messages in an order according to rank in response to receiving a scroll signal from the operator interface 135 by touching the scroll arrow touch element 420. In embodiments, if the operator 140 has not sent a scroll signal by touching the scroll arrow touch element 420 for a predetermined amount of time (e.g., five seconds), the controller 145 can be adapted to automatically page through the active pop-up messages, sequentially displaying each active pop-up message for a predetermined amount of time or until the operator 140 presses the scroll arrow touch element 420.

In embodiments, if multiple information pop-up messages are active, the pop-up message 410 can include indicia 425 indicating the number of active pop-up messages as well as the number of that particular pop-up message. For example, the illustrated indicia 425 comprises the text string “2/4,” which indicates this particular pop-up message 410 is the second pop-up message of four active pop-up messages.

Referring to FIGS. 11-13, embodiments of pop-up messages 410, 510, 610 are respectively shown. Each of the pop-up messages 410, 510, 610 in FIGS. 11-13 can have the same pop-up message configuration 310 as shown in FIG. 10, but also include indicia that informs the operator of the rank of the respective pop-up message 410, 510, 610 in the priority hierarchy.

In embodiments, the controller can be adapted to include indicia in each pop-up message signifying the rank of the particular pop-up message in the priority hierarchy. The controller can be adapted to rank active pop-up messages in a priority hierarchy and sequentially display the active pop-up messages, each for a period of time, in an order according to rank. The controller can be adapted to rank the active pop-up messages in the priority hierarchy and sequentially display the active pop-up messages in an order according to rank in response to receiving a scroll signal from the operator interface.

For example, the pop-up message 410 in FIG. 11 comprises a Warning Level 1 pop-up message. The pop-up message area box 440 of the Warning Level 1 pop-up message 410 can contain rank indicia 445 that indicates its rank in the priority hierarchy. In embodiments, the rank indicia 445 of the Warning Level 1 pop-up message 410 can include a text string 450 and a background color 452 of the pop-up message area box 440.

For example, in one embodiment, the text string 450 includes a suffix, “−1,” which indicates the pop-up message 410 of FIG. 11 comprises a Warning Level 1 pop-up message. In embodiments, the indicia of different ranks in the priority hierarchy comprise a plurality of different colors which correspond to different ranks in the priority hierarchy. For example, in one embodiment, the priority hierarchy includes a Warning Level 1 indicated by the color grey, a Warning Level 2 indicated by the color yellow, and a Warning Level 3 indicated by the color red. The illustrated background color 452 of the pop-up message area box 440 is grey to also signify the pop-up message 410 of FIG. 11 comprises a Warning Level 1 pop-up message.

In embodiments, the Level 1 Warning pop-up message 410 can be “snoozed” for a predetermined amount of time, after which it reappears if the machine condition generating the warning is still active. In embodiments, the Level 1 Warning pop-up message 410 can be snoozed for a programmable amount of time in a range up to twelve hours.

Referring to FIG. 12, an embodiment of a Level 2 Warning pop-up message 510 is shown. In embodiments, the Level 2 Warning pop-up message 510 is ranked in a priority hierarchy to supersede any active Level 1 Warning pop-up messages.

The pop-up message area box 540 of the Warning Level 2 pop-up message 510 can contain rank indicia 545 that indicates its rank in the priority hierarchy. In embodiments, the rank indicia 545 of the Warning Level 2 pop-up message 510 can include a text string 550 and a background color 552 of the pop-up message area box 540.

For example, in one embodiment, the text string 550 includes a suffix, “−2,” which indicates the pop-up message 510 of FIG. 12 comprises a Warning Level 2 pop-up message. The illustrated background color 552 of the pop-up message area box 540 is yellow to also signify the pop-up message 510 of FIG. 12 comprises a Warning Level 2 pop-up message.

In embodiments, the Level 2 Warning pop-up message 510 can be “snoozed” for a predetermined amount of time, after which it reappears if the machine condition generating the warning is still active. In embodiments, the Level 2 Warning pop-up message 510 can be snoozed for a programmable amount of time in a range up to thirty minutes.

Referring to FIG. 13, an embodiment of a Level 3 Warning pop-up message 610 is shown. In embodiments, the Level 3 Warning pop-up message 610 is ranked as the highest priority in a priority hierarchy to supersede any active Level 1 and Level 2 Warning pop-up messages.

The pop-up message area box 640 of the Warning Level 3 pop-up message 610 can contain rank indicia 645 that indicates its rank in the priority hierarchy. In embodiments, the rank indicia 645 of the Warning Level 3 pop-up message 610 can include a text string 650 and a background color 652 of the pop-up message area box 640.

For example, in one embodiment, the text string 650 includes a suffix, “−3,” which indicates the pop-up message 610 of FIG. 13 comprises a Warning Level 3 pop-up message. The illustrated background color 652 of the pop-up message area box 640 is red to also signify the pop-up message 610 of FIG. 13 comprises a Warning Level 3 pop-up message.

If multiple pop-up messages are active, a scroll arrow touch element 620 and indicia 625 shall appear indicating so. In embodiments, pressing the scroll arrow touch element 620 allows the operator 140 to page through all active pop-up messages, including active pop-up messages having a lesser rank. In embodiments, if the operator 140 has not pressed the scroll arrow touch element 620 for a predetermined amount of time (e.g., 5 seconds), the controller 145 can be adapted to sequentially display active Warning Level 3 pop-up messages only.

In embodiments, the Level 3 Warning pop-up message 610 can be “snoozed” for a predetermined amount of time (e.g., 5 minutes), after which it reappears if the machine condition generating the warning is still active. In embodiments, at least one Level 3 Warning pop-up message is configured such that it does not have an enabled snooze feature.

In embodiments, a priority hierarchy can include warning pop-up messages as described above and information pop-up messages, which can be used to provide non-safety critical messages to the operator. In embodiments, the information pop-up message can have a high level of configurability, thereby allowing each information pop-up message to be individually-customized to provide the appropriate information. The information pop-up message can include a text string comprising complete words to allow for greater understanding and better translation into different languages. In embodiments, an information pop-up message is superseded by an active Level 1 Warning pop-up message.

### INDUSTRIAL APPLICABILITY

Embodiments of an information display system for a machine are described herein. The industrial applicability of embodiments constructed according to principles of the present disclosure of an information display system for a machine will be readily appreciated from the foregoing discussion. The described principles are applicable for use in multiple embodiments of a machine, including trucks, cranes, earth moving vehicles, mining vehicles, cold planers, wheel loaders, backhoes, motor graders, track type tractors, hydraulic excavators, track type loaders, material handling equipment, farming equipment, marine vessels, aircraft, and other types of movable machines.

The disclosed systems and methods may provide a multi-functional user interface on a work machine to display information associated with the operations of the work machine. This information may include suggested corrective actions associated with detected abnormal operational conditions and/or service-triggering conditions of the machine.

In embodiments, an information display system for a machine includes a display screen having a dedicated information banner. The display screen is configured to maintain display of machine parameters and productivity information and simultaneously display the information banner. The information banner displays sacrificial information of lower priority when warning messages are not needed (such as operator name, temperature, time, etc.) and display critical message and/or warnings when needed.

When a machine condition is detected that triggers a pop-up message, the pop-up message is displayed in the information banner, and the sacrificial information is overwritten. An operator can touch the banner or button to snooze the pop-up message. The information banner again displays the sacrificial information and also displays an alert reminder symbol to indicate an active pop-up message has been removed from the display screen. The operator can touch the reminder symbol to launch a display that shows a list of warnings that have accumulated. The operator can select one of the warnings to launch another display having the details of the selected warning.

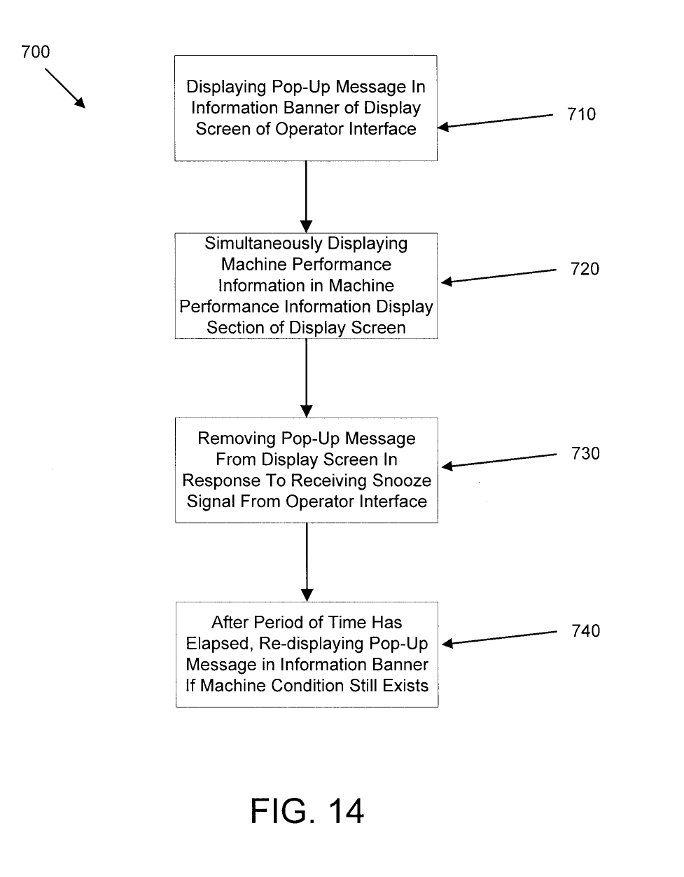

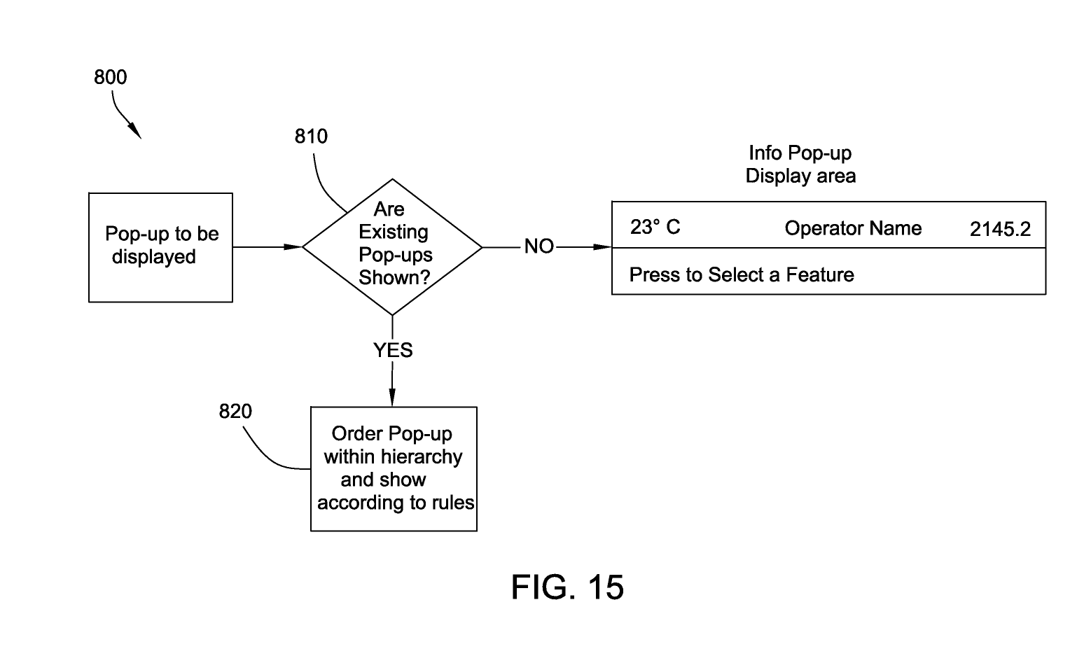

Referring to FIG. 14, steps of an embodiment of a method 700 of displaying operational information of a machine following principles of the present disclosure are shown in flowchart form. In response to receiving an indication of a machine condition, a pop-up message is displayed in an information banner of a display screen of an operator interface (step 710). The pop-up message includes data describing the machine condition. Machine performance information is simultaneously displayed in a machine performance information display section of the display screen (step 720). The information banner is disposed in non-overlapping relationship with the machine performance information display section of the display screen. In response to receiving a snooze signal from the operator interface, the pop-up message is removed from the display screen for a period of time (step 730). After the period of time has elapsed, the pop-up message is re-displayed in the information banner of the display screen if the machine condition still exists (step 740).

Referring to FIG. 15, steps of an embodiment of a method 800 of displaying operational information of a machine following principles of the present disclosure are shown in flowchart form. In response to receiving indications that a plurality of predetermined machine conditions exist (step 810), a corresponding plurality of pop-up messages can be ranked according to a priority hierarchy (step 820). The plurality of pop-up messages can be sequentially displayed in the information banner according to the ranking.

In embodiments, the controller 145 can be adapted to display new pop-up messages in an order of highest priority first. For example, any existing Level 3 Warning pop-up messages can take precedence over other active pop-up messages and will not cycle on their own. If there are simultaneous level 2 and level 1 conditions, then a Level 2 Warning pop-up messages can be shown prior to scrolling through active Level 1 Warning pop-up messages. New Level 2 warning pop-up messages take priority over any active pop-up messages other than Level 3 Warning pop-up messages. Reoccurring previously-snoozed Level 2 Warning pop-up messages are treated as a new message of the same severity. New Level 1 Warning pop-up messages are added to the list of Level 1 Warning pop-up messages and shown when the scroll list of the Level 2 Warning pop-up messages is complete. Reoccurring, previously-snoozed Level 1 Warning pop-up messages can be treated as a new message of the same severity. A display rate (e.g., five seconds) can be used to show multiple pop-up messages if the scroll arrow touch element in the displayed pop-up message is not engaged.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for the features of interest, but not to exclude such from the scope of the disclosure entirely unless otherwise specifically indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

What is claimed is:

1. An information display system for a machine, comprising:
an operator interface including a display screen, the display screen having a machine performance information display section adapted to display information indicating at least one machine parameter and a message display section adapted to selectively display a plurality of pop-up messages, the message display section being disposed in offset relationship to the machine performance information display section;
a data storage device, the data storage device storing message data; and
a controller operably arranged with the data storage device and the operator interface, the controller, in response to receiving a signal indicative of a first machine condition, adapted to assemble from the message data in the data storage device a first pop-up message describing the first machine condition and to provide the first pop-up message to the operator interface for display in the message display section of the display screen;
wherein the controller is adapted to remove the first pop-up message from the display screen for a first period of time in response to receiving a first hide signal from the operator interface and to re-display the first pop-up message in the message display section of the display screen after the first period of time has elapsed if the first machine condition still exists.

2. The information display system of claim 1, wherein the display screen comprises a touch screen configured to trigger the first hide signal in response to an object touching the message display section of the display screen with a predetermined amount of force.

3. The information display system of claim 1, wherein the controller is adapted to provide sacrificial information to the operator interface for display in the message display section of the display screen when the controller has not received any signal indicative of a machine condition predetermined to trigger a pop-up message.

4. The information display system of claim 3, wherein the controller is adapted to overwrite the sacrificial information in the message display section of the display screen with the pop-up message when the controller receives the signal indicative of the first machine condition.

5. The information display system of claim 4, wherein the controller is adapted to display the sacrificial information in the message display section of the display screen after receiving the first hide signal from the operator interface.

6. The information display system of claim 1, wherein the controller is adapted to display an alert reminder symbol in the message display section of the display screen after removing the first pop-up message from the display screen for the first period of time in response to receiving the first hide signal from the operator interface.

7. The information display system of claim 6, wherein the controller is adapted to display the alert reminder symbol in the message display section of the display screen until the first period of time has elapsed and the first pop-up message is re-displayed in the message display section of the display screen or until the controller determines the first machine condition no longer exists, whichever occurs first.

8. The information display system of claim 1, wherein the controller is adapted to assemble from the message data in the data storage device a second pop-up message describing the second machine condition in response to receiving a signal indicative of a second machine condition and to provide the second pop-up message to the operator interface for display in the message display section of the display screen.

9. The information display system of claim 8, wherein the controller is adapted to determine whether the first pop-up message is displayed in the message display section of the display screen and, if so, rank the first pop-up message and the second pop-up message in a priority hierarchy and sequentially display the first pop-up message and the second pop-up message in an order according to rank.

10. The information display system of claim 8, wherein the controller is adapted to rank the first pop-up message and the second pop-up message in a priority hierarchy, and the controller is adapted to sequentially display the first pop-up message and the second pop-up message in an order according to rank in response to receiving a scroll signal from the operator interface.

11. The information display system of claim 8, wherein the controller is adapted to assign a rank to each of the first pop-up message and the second pop-up message in a priority hierarchy, the first pop-up message including indicia signifying the rank of the first pop-up message in the priority hierarchy, and the second pop-up message including indicia signifying the rank of the second pop-up message in the priority hierarchy.

12. The information display system of claim 8, wherein the controller is adapted to remove the second pop-up message from the display screen for a second period of time in response to receiving a second hide signal from the operator interface and to re-display the second pop-up message in the message display section of the display screen after the second period of time has elapsed if the second machine condition still exists.

13. The information display system of claim 12, wherein the controller is adapted to display an alert reminder symbol in the message display section of the display screen after removing the first pop-up message and the second pop-up message from the display screen in response to receiving the first hide signal and the second hide signal, respectively, from the operator interface.

14. The information display system of claim 13, wherein the controller is adapted to display the alert reminder symbol in the message display section of the display screen until the first period of time has elapsed and the first pop-up message is re-displayed in the message display section of the display screen, the second period of time has elapsed and the second pop-up message is re-displayed in the message display section of the display screen, or until the controller determines both the first machine condition and the second machine condition no longer exist, whichever occurs first.

15. The information display system of claim 13, wherein the controller is adapted to assign a rank to each of the first pop-up message and the second pop-up message in a priority hierarchy, the first pop-up message including indicia signifying the rank of the first pop-up message in the priority hierarchy, and the second pop-up message including indicia signifying the rank of the second pop-up message in the priority hierarchy, and to determine a highest rank in which at least one of the first pop-up message and the second pop-up message is assigned, and wherein the alert reminder symbol includes indicia corresponding to the highest rank in the priority hierarchy.

16. The information display system of claim 13, wherein the controller is adapted to display a diagnostic list in the machine performance information display section in response to receiving a diagnostic list signal from the operator interface, the diagnostic list including a list of each of the first pop-up message and the second pop-up message in an active condition.

17. A machine adapted to be controlled by an operator, comprising:
a frame;
a plurality of ground-engaging devices mounted to the frame;
an engine operably coupled to at least one of the plurality of ground-engaging devices;
an operator compartment supported by the frame; and
an information display system, the information display system including:
an operator interface disposed within the operator compartment, the operator interface including a display screen, the display screen having a machine performance information display section adapted to display information indicating at least one machine parameter and a message display section adapted to selectively display a plurality of pop-up messages, the message display section being disposed in offset relationship to the machine performance information display section,
a data storage device, the data storage device storing message data, and
a controller operably arranged with the data storage device and the operator interface, the controller, in response to receiving a signal indicative of a first machine condition, adapted to assemble from the message data in the data storage device a first pop-up message describing the first machine condition and to provide the first pop-up message to the operator interface for display in the message display section of the display screen,
wherein the controller is adapted to remove the first pop-up message from the display screen for a first period of time in response to receiving a first hide signal from the operator interface and to re-display the first pop-up message in the message display section of the display screen after the first period of time has elapsed if the first machine condition still exists.

18. The machine of claim 17, further comprising:
sensors, the sensors being in electrical communication with the controller, each sensor adapted to detect an operational parameter of the machine and to provide a signal indicative of a value of said operational parameter to the controller;
wherein the controller is adapted to provide operational parameter information to the operator interface for display in the machine performance information display section of the display screen.

19. A method of displaying operational information of a machine, comprising:
in response to receiving an indication of a machine condition, displaying a pop-up message in an information banner of a display screen of an operator interface, the pop-up message including data describing the machine condition;
simultaneously displaying machine performance information in a machine performance information display section of the display screen, the information banner being disposed in non-overlapping relationship with the machine performance information display section of the display screen;
in response to receiving a snooze signal from the operator interface, removing the pop-up message from the display screen for a period of time; and
after the period of time has elapsed, re-displaying the pop-up message in the information banner of the display screen if the machine condition still exists.

20. The method of displaying operational information of a machine according to claim 19, further comprising:
in response to receiving indications that a plurality of predetermined machine conditions exist, correspondingly ranking a plurality of pop-up messages according to a priority hierarchy; and
sequentially displaying the plurality of pop-up messages in the information banner according to the ranking.
